(19) United States
(12) Patent Application Publication
(10) Pub. No.: US 2017/0316530 A1
(43) Pub. Date: Nov. 2, 2017

(54) Method and System for Providing Reports and Segmentation of Physician Activities

(71) Applicant: Quintiles IMS Incorporated, Danbury, CT (US)

(72) Inventors: Andrew E. Kress, Gladwyne, PA (US); Jody Fisher, Voorhees, NJ (US); Steven Rosztoczy, Warrington, PA (US)

(21) Appl. No.: 15/599,245

(22) Filed: May 18, 2017

Related U.S. Application Data
(63) Continuation of application No. 12/481,321, filed on Jun. 9, 2009.
(60) Provisional application No. 61/111,170, filed on Nov. 4, 2008.

(51) Int. Cl. G06Q 50/22; G06Q 50/24; G06Q 10/06

(52) U.S. Cl. CPC G06Q 50/22; G06Q 10/06; G06Q 50/24

(57) ABSTRACT

A system includes a database with at least one dataset with at least one data field corresponding to at least one field of data of a medical claim form, a computing platform in communication with the database, and a memory module. The at least one dataset is formed from de-identified provider information. The memory module contains at least one conversion table for converting between a provider identification code and a corresponding provider name. The computing platform receives a request for information, extracts from the database one or more datasets having information responsive to the request, and forms an output table based on the extracted one or more datasets. The table includes the provider name.

### CROSS-REFERENCE TO RELATED APPLICATION

This application claims priority to U.S. Provisional Patent Application No. 61/111,170, entitled “Method and System for Providing Reporting and Segmentation of Physician Activities” by Andrew Kress et al., filed on Nov. 4, 2008, the entire disclosure of which is incorporated herein by reference.

### FIELD OF THE INVENTION

The present invention relates to a method and a system for providing reports of activities of healthcare providers.

### BACKGROUND OF THE INVENTION

In the healthcare system, there are generally patients, providers, and payers. A patient is a person who comes to the provider for diagnoses or treatment of medical conditions. Providers include medical practitioners and professionals (such as dentists, nurse practitioners, physicians, and therapists) as well as healthcare facilities (such as private offices, hospitals, and outpatient centers), medical service providers (such as pharmacies and laboratories) and other individuals or companies which provide medical diagnosis and treatment services. Payers are payment organizations which assist patients in paying for the diagnosis and treatment fees, and include privately owned health insurance companies, as well as publicly funded programs including Medicare, and Medicaid.

When a patient visits a provider for a diagnosis or treatment, the patient incurs a service fee. Depending on the patient's health insurance plan, the patient may have to pay a portion of the service fee to the provider, also known as a co-payment. The patient or the provider then fills out a medical insurance claim form and submits it to one or more payers to collect the rest of the service fee.

The payers and other organizations have standardized medical claim forms to help the payers and providers communicate with each other in a uniform manner. An exemplary standardized claim form is shown in FIGS. 1a, 1b, taken from U.S. Pat. No. 7,386,526 which is incorporated herein by reference. As shown in FIG. 1, the sample claim form includes 85 identified fields for entry of information and codes. For instance, field 1 is used for entry of the provider name, address, and telephone number. Fields 12-16 are used for entry of the patient's personal information, such as name, address, birth date, and gender. Fields 67-81 are used for entry of codes corresponding to the diagnosis and procedure performed by the provider. Field 82 is used for entry of an identification code of the attending physician. Each doctor is identified by a physician identification code, rather than by their name, on the medical claim form. Typically, a third party or a manually created conversion table is used to convert between the identification code and the physician's name.

Instead of writing down on the claim form the complete diagnoses or procedures that were performed, the provider can utilize a code corresponding to the respective diagnosis and procedure. Diagnosis and procedure codes are standardized and established by healthcare industry standards groups, such as the National Uniform Billing Committee (NUBC), State Uniform Billing Committee (SUBC), American Medical Association (AMA), and Drug Enforcement Administration (DEA).

There are various diagnosis and procedure coding systems for different fields of medicine, services, and treatments. Each coding system contains thousands of unique diagnosis or procedure codes for providers to use in filling out the medical claim forms. One diagnosis coding system is the International Classification of Disease with Clinical Modifications, 9th Revision (ICD-9 CM, hereinafter “ICD-9”), developed by the World Health Organization. Payers and providers commonly use the ICD-9 codes on medical claim forms to describe diagnoses of symptoms, injuries, diseases, and medical conditions. For example, the ICD-9 code 414.0 would be typically recorded for patients who were diagnosed with the condition of Coronary Atherosclerosis. One procedure coding system is the Current Procedure Terminology (CPT) developed by the AMA. Payers and providers commonly use CPT codes to describe procedures or services that providers may perform on patients. These procedures and serviCes are then subsequently reimbursed by the payer, such as an insurer. For example, on a medical claim form, CPT 31255 code indicates that a provider has performed a surgical nasal or sinus endoscopy on the patient. The DEA also developed a Healthcare Common Procedure Coding System (HCPCS) which is a set of procedure codes based on the CPT codes.

In addition, field 82 requires a physician identification code (rather than the physician's name), and fields 12-20 require patient name, gender and age, and date of service. There can also be fields for hospital affiliation, group practice, and other information. Thus, each medical claim form provides a wide range of information related to the provider's activities.

As the healthcare industry grows, the number of medical claims being submitted has increased tremendously. Because of the voluminous amount of medical claims being submitted daily from a large number of providers, many providers and payers have a difficult time managing the medical claims. As a result, clearinghouses have developed to assist payers and providers in dealing with the claim submission process. The clearinghouses receive medical claim forms from the providers, ensure that the forms are properly completed, and distribute the claim forms to the payers. The clearinghouses also distribute the status of submitted claim forms, such as rejected or accepted, from the payers to the providers. Recently, the processing of claim forms has been enhanced by electronic processing of these claim forms. Approximately 90% of all medical claim forms are processed electronically for payment. Electronic processing is further enhanced by use of standard format medical claim forms, such as those in the CMS standard 837i format.

FIG. 2 is a diagram that illustrates an exemplary system 200 for providers to submit medical insurance claims to payers. The system 200 includes providers 202, medical claim forms 204, clearinghouses 206, and payers 208. The providers 202 submit the claim forms 204 to the clearinghouses 206 by paper or electronically as a file or other suitable format. The clearinghouses 206 collect the claim forms 204 from the providers 202, and distribute them to the payers 208. The providers 202 can be physicians who provide diagnoses and treatment procedures for patients. The providers can be affiliated with private physician offices, hospitals, and other types of healthcare facilities.

Many companies, such as pharmaceutical and medical device manufacturers and organizations related to healthcare, have a great interest in promoting their products and services to specific groups of providers 202. To promote their products and services effectively, those companies want to target their products not to all providers 202, but to the most relevant group of providers 202 in a specialized field. Thus, before promotion, a company would want a list of providers 202, such as physicians who performed particular diagnoses and procedures in the field of medicine that would most need the company's products. The providers 202 on the list would be more likely than others to use or introduce the company's products to their patients. For instance, a manufacturer of a device for measuring blood sugar level may want, a list of the top 100 physicians in the country that performed the highest number of diabetes diagnoses and treatments in the previous year. Those physicians are more likely than others to diagnose and treat diabetic patients in the near future and introduce the company's blood-level measuring device to their patients. Moreover, the manufacturer may want the list of the top 100 physicians to be sorted by the total number of diagnoses performed, or by gender and age range of the patients. Such a reporting list of physician activities would help the manufacturer to strategize business planning and maximize return on promotions.

Companies that offer reporting lists of provider activities generally obtain their information from the providers 202. However, the information from many providers 202 is often summary data of the total number of diagnoses and treatments that the providers 202 have performed. For instance, a hospital provides a summary for its many physicians. Those summaries typically do not provide breakdowns of how many diagnoses and treatments each physician affiliated with the hospital has performed. Thus, to estimate how many diagnoses or procedures each physician performed, the total number of services provided by the hospital is divided by the number of physicians. As a result of this crude apportioning approach, summary reports of physician activities do not accurately reflect the actual number of diagnoses and procedures that each physician actually performed.

Thus, there is a need for a system to generate reports of provider activities derived from a database that includes information derived from standardized and electronically processed medical claims data linked to each individual provider who performed the diagnoses and procedures.

### SUMMARY OF THE INVENTION

It is therefore an object of the invention to provide a method and a system for providing reporting and segmentation of provider activities from sources of data that are linked to individual physicians. It is a further object of the invention to provide reporting and segmentation of provider activities from a data source that has a wide range of information from provider profile to gender and age of patients, to payment types and names of payers, and to hospital affiliations, among others.

An exemplary embodiment of the present invention provides a system. The system includes a database with at least one dataset with at least one data field corresponding to at least one field of data of a medical claim form, a computing platform in communication with the database, and a memory module. The at least one dataset is formed from de-identified provider information. The memory module contains at least one conversion table for converting between a provider identification code and a corresponding provider name. The computing platform receives a request for information, extracts from the database one or more datasets having information responsive to the request, and forms an output table based on the extracted one or more datasets. The table includes the provider name.

Another exemplary embodiment of the present invention provides a method of providing an output of providers. The method includes the steps of: obtaining a medical claim form with a provider identification code and at least one field of data; forming a dataset with a plurality of data fields; relating one of the plurality of data fields with the provider identification code; relating another one of the plurality of data fields with the at least one field of data of the medical claim form; searching the dataset for a particular entry in the at least one data field; extracting one or more datasets with a substantially matching entry; converting provider identification codes of the one or more extracted datasets into a provider name; and providing an output table with the one or more provider names formed from the one or more extracted datasets.

Yet another exemplary embodiment of the present invention provides a system. The system includes a database containing datasets, a processor in communication with the database, and a memory module in communication with the processor. The datasets include data fields. Each of the data fields correspond to one of the fields of data of a medical claim form. The database is in communication with a clearinghouse that receives medical claim forms. Each of the medical claim forms includes a provider identification code in one of the fields of data. The memory module contains at least one conversion table for converting between the provider identification code and a corresponding provider name. The processor receives a request for information, extracts from the database one or more datasets having information responsive to the request, converts the provider identification code of the one or more extracted datasets into a provider name, and forms an output table based on the extracted one or more datasets. The output table includes the one or more provider names arranged according to the occurrence of the particular entry in the medical claim forms submitted by the providers.

### BRIEF DESCRIPTION OF THE DRAWINGS

FIG. 1 is a diagram of an exemplary medical claim form, according to the prior art;

FIG. 2 is a diagram of a system where healthcare providers can submit medical claim forms to payers, according to the prior art;

FIG. 3 is a system for providing reports and segmentation of provider activities, according to an exemplary embodiment of the present invention;

FIG. 4 is a method for providing reports and segmentation of provider activities, using the system of FIG. 3;

FIG. 5 is a flow diagram of a method for providing a data grade to the providers listed in an output table of the present invention;

FIG. 6 is a flow diagram of another method for providing reports and deciles of provider activities, according to another exemplary embodiment of the present invention;

FIG. 7 is a flow diagram of a method for ordering a report and segmentation of provider activities online, according to an exemplary embodiment of the present invention; and

FIGS. 8-11 are exemplary output tables of the present invention.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose.

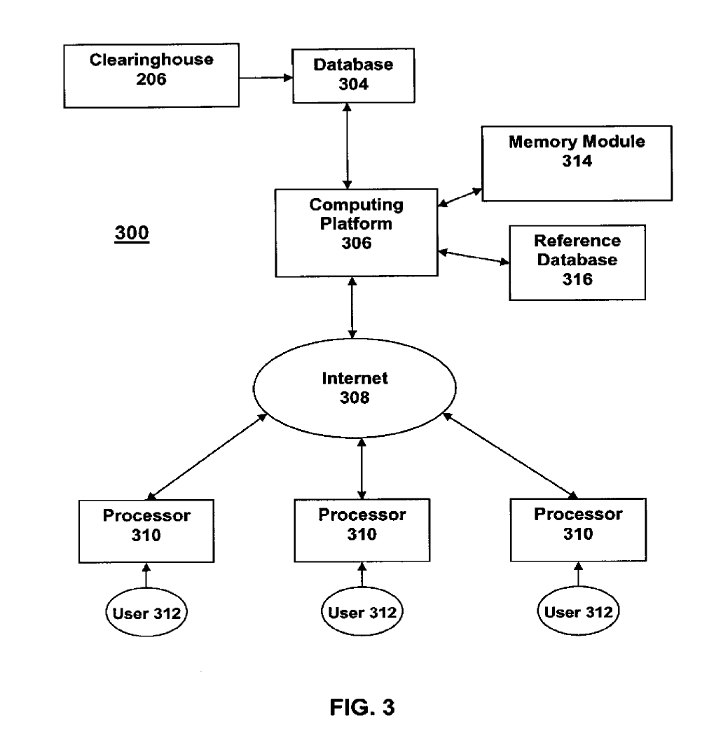

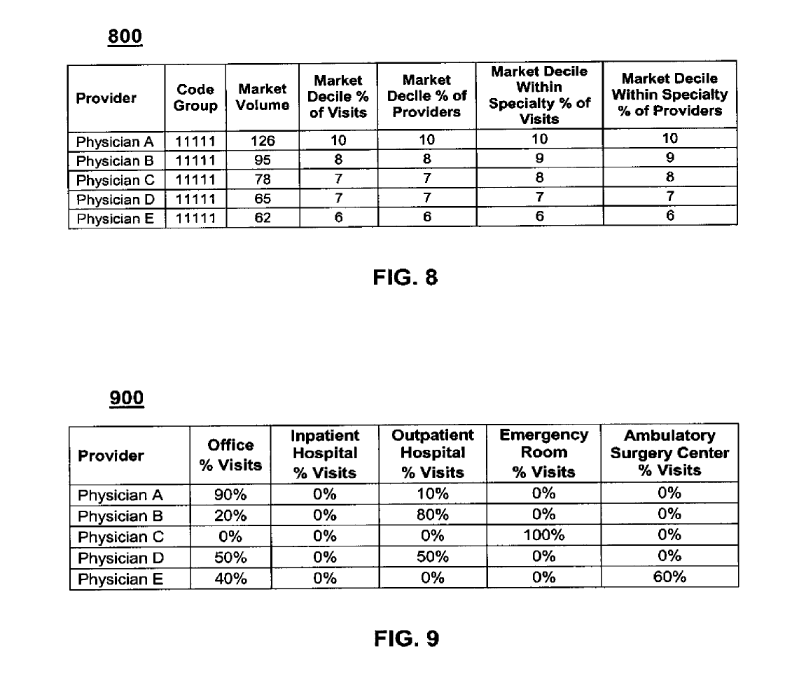

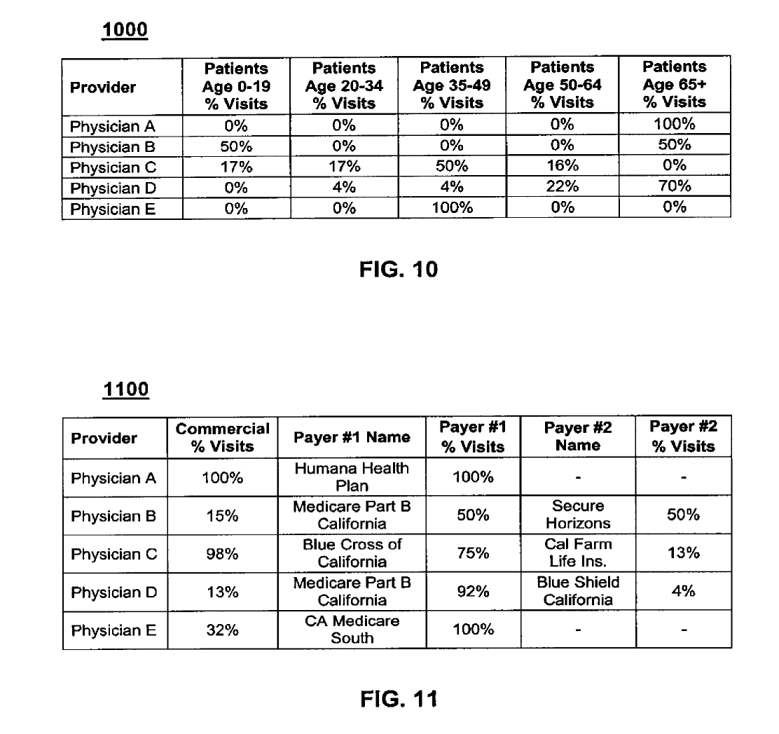

Turning to the drawings, FIG. 3 shows a system 300 for generating a report and segmentation of provider 202 activities according to an exemplary embodiment of the present invention. The system 300 generates reports, such as ones shown in FIGS. 8-11, that are derived from the information contained in the medical claim forms 204 and that extract data related to one or more particular activities of particular providers 202. The system 300 can provide reports with a listing of providers 202, such as physicians, who most frequently diagnose or treat a particular ailment, such as the report shown in FIG. 8; a listing of physicians who most frequently diagnose or treat a particular ailment at a particular location, such as the report shown in FIG. 9; a listing of physicians who most frequently diagnose or treat a particular ailment and demographic data of their patients, such as the report shown in FIG. 10; or a listing of physicians who most frequently diagnose or treat a particular ailment and the type of payments that the physician receives, such as the report shown in FIG. 11. Because the system 100 generates reports based on medical claim forms 204, the generated reports include data with large sample sizes, data that can be associated with one or more particular providers 202, and data with near real-time updates. Thus, the reports are substantially unaffected by errors due to small sample sizes, inherent inaccuracies of apportioning or imputation methods, or possibly obsolete data.

The system 300 includes, at least, a database 304 and a computing platform 306. The database 304 is in communication with the clearinghouse 206 and the computing platform 306. The computing platform 306 can also be in communication with a memory module 314, a reference database 316, and a plurality of processors 310. In the embodiment shown, the computing platform 306 communicates with the processors 310 through the Internet 308, and users 312 interface with the system 300 through the processors 310. The system 300 in FIG. 3 can be a network configuration or a variety of data communication network environments using software, hardware, or a combination of hardware and software to provide the computing and processing functions. All or parts of the system 300 and processes can be stored on or read from computer-readable media. Common forms of computer-readable media include, for example, a floppy disk, a flexible disk, a hard disk, magnetic tape, any other magnetic medium, a CD-ROM, a DVD, any other optical medium, punch cards, paper tape, any other physical medium with patterns of holes, a RAM, a PROM, an EPROM, a FLASH-EEPROM, any other memory chip or cartridge, a carrier wave as described hereinafter,—or any other medium from which a computer can read.

Furthermore, though the database 304, the memory module 314, and the reference database 316 are shown separately, they can be combined into one module. Where any databases are described, it will be understood that other memory structures besides databases may be readily employed.

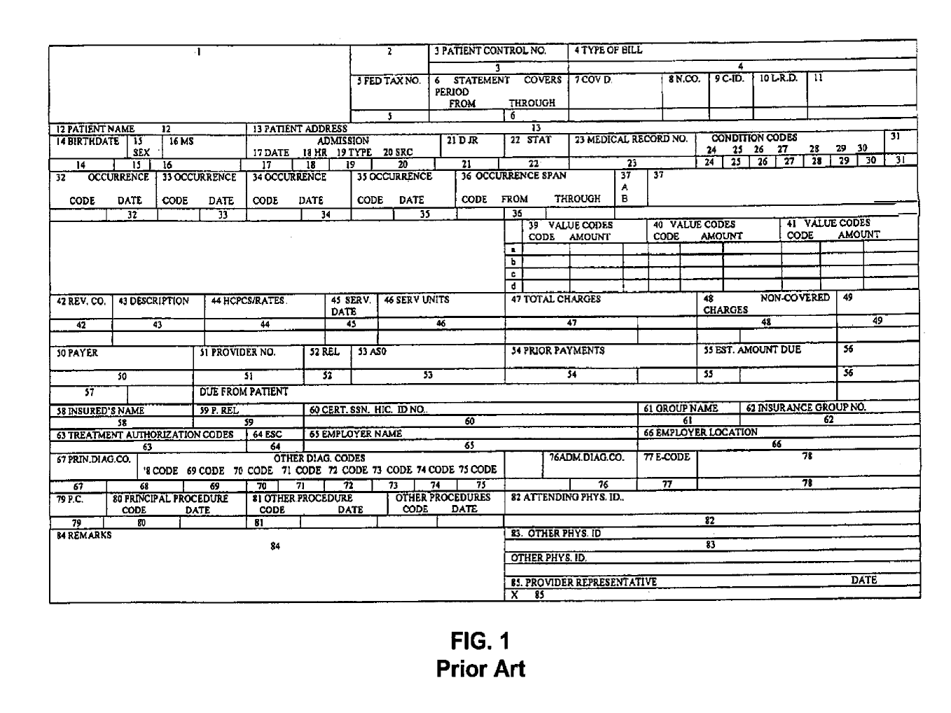

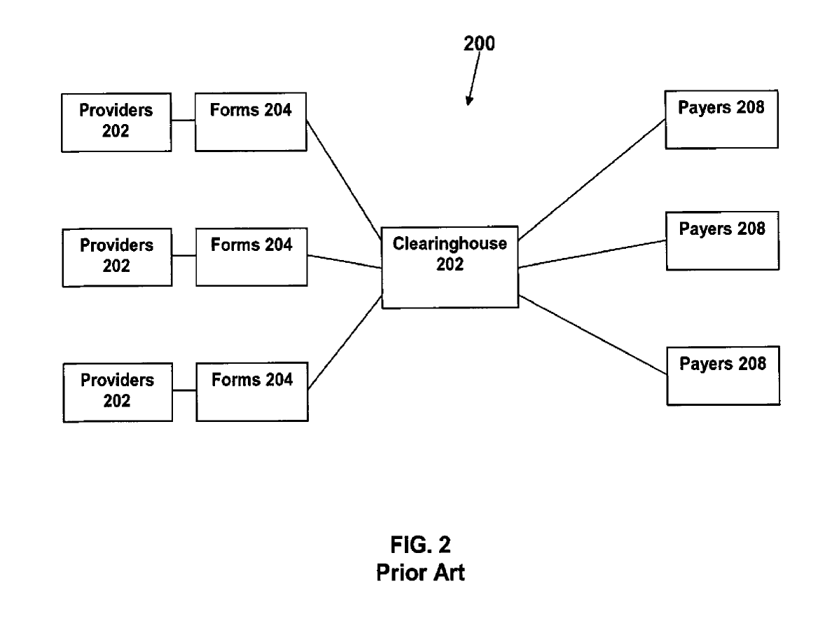

The clearinghouse 206 collects medical claim forms 204 from providers 202 and converts the information from the medical claim forms 204 into medical claim data. For example, in the embodiment shown, the clearinghouse 206 reads the fields of the sample claim form shown in FIG. 1, and converts the data in those fields into an electronic form. Although the medical claim data is primarily for payers 208, the system 300 can obtain and manipulate that data so that it is usable by the system 300. The clearinghouse 206 sends the medical claim data to the payers 208 and the database 304.

The database 304 stores the medical claim data. The medical claim forms 204 used to provide medical claim data can come from any source. In the embodiment shown, the database 304 is in communication with one or more clearinghouses 206 that collect medical claim forms 204 for payers 206 and stores medical claim data received from the clearinghouse 206 in a dataset. The system 300 can also be enhanced with other company datasets and advanced analytics, including prescription volume, consumer demographic and lifestyle attributes, and hospital profile information.

The database 304 can be remotely located from the clearinghouse 206. Also, the database 304 can receive medical claim data as soon as the clearinghouse 206 converts the medical claim forms 204 into medical claim data, or the database 304 receives the medical claim data some time period after the clearinghouse 206 converts the medical claim forms 204 into medical claim data. In the embodiment shown, the medical claim forms 204 submitted by providers 202 can be delivered for use by the system 300 within 24 hours of submission of a medical claim form 204. Because the clearinghouses 206 receive medical claim forms 204 at various times throughout a day, the system 300 can update the database 304 once daily with medical claim data formed in the previous day. Thus, the database 304 is based upon medical claim forms 204 that contain information about provider 202 activities, such as diagnoses and procedures performed, and information about the patient shortly after a patient's visit with a provider 202. Accordingly, instead of providing reports based on summary data that includes the total number of diagnoses and treatments that a group of providers 202 have performed, the database 304 provides reports with the actual diagnoses and treatments that each particular provider 202 performed according to the medical claim forms 204 each provider 202 submitted. Therefore, the database 304 does not divide the total number of diagnoses and treatments by the total number of providers 202 in a group which often provides inaccurate data. Also, the system 300 can provide reports representing the near real time behavior of providers 202. In one embodiment, an output, such as a report or an output table, can be provided to the user 312 within approximately 72 hours of the user 312 submitting a request for an output from the system 300. In benchmark testing of performance, for a request based on a large selection of most often used ICD-9/CPT codes and a search involving approximately 12 months of medical claim forms data, the embodiment took approximately 72 hours to respond to the submitted request. Forming an output in response to a particular request can take up to 72 hours if the request requires searching a large number of datasets. More time may be required for searching larger amounts of datasets, filtering larger search results, or presenting the filtered or unfiltered results in a particular format for the user 312.

The medical claim forms 204 submitted by the providers 202 to the clearinghouses 206 include one or more fields of data, and each field of data has a corresponding field in the dataset that is stored in the database 304. Thus, each dataset includes a separate field for each of the information entered on the form 204, including the diagnosis or procedure code, the physician identification code, date of service, patient information (such as the patient gender and age), location of care, names of payers, pay types, hospital affiliation, practice group, and other information provided on a medical claim form 204. To protect patients' privacy and doctor-patient privilege, and comply with Health Insurance Portability and Accountability Act (HIPAA) requirements, the computing platform 306 preferably excludes the names and other patient identifying information of the patients from the database 304. Thus, the name and other patient identifying information are excluded from the dataset stored in the database 304. In other embodiments, a portion of the patient identifying information can be converted into a unique encrypted patient identifier, and the unique encrypted patient identifier can replace all or a portion of the patient identifying information.

The computing platform 306 is in communication with the database 304. In the embodiment shown, the computing platform 306 is also in communication with the memory module 314, the reference database 316, and the processors 310. Also, the computing platform 306 communicates with the processors 310 through the Internet 308, however, in other embodiments, the computing platform 306 can communicate with the processors 310 through hardwire, a local area network, a wireless connection, combinations of the aforementioned, or some other form of communication. The computing platform 306 performs various functions and operations in accordance with the invention. The computing platform 306 can be, for instance, a personal computer (PC), server, or mainframe computer. The computing platform 306 can be a general purpose computer reconfigured by a computer program, or may be specially constructed to implement the features and operations of the system 300. The computing platform 306 may also be provided with one or more of a wide variety of components or subsystems including, for example, a processor, co-processor, register, data processing devices, and subsystems, wired or wireless communication links, input devices, monitors, memory or storage devices such as a database.

Because the system 300 generates reports based on at least one particular data field in the medical claim forms 204 or in the datasets of the database 304, the computing platform 306 searches the datasets in the database 304 for datasets with substantially matching data in a particular data field. To simplify the description of the invention without intending to limit the invention, the system 300 described searches the datasets for a particular code in the diagnosis code data field (such as fields 68-75 of the claim form shown in FIG. 1) or in the procedure code data field (such as fields 80-81 of the same claim form). However, in other embodiments, the system 300 can search other data fields, and the invention is not intended to be limited to searches of only the diagnosis code data field or the procedure code data field.

The system 300 can include one or more modules for converting between data in a particular field of the dataset stored in the database 304 and further related or background information associated with the data in the field. In the embodiment shown, the system 300 includes the memory module 314 and the reference database 316. The memory module 314 stores one or more lookup tables for converting between a provider identification code and its associated provider information, such as name, gender, age, specialty, practice group, hospital affiliation, licensing information, medical school information, and other similar background information. In the embodiment shown, the memory module 314 has a table for converting between a particular provider identification code and the corresponding name of the provider 202. A separate database, the reference database 316, stores other related or background information of providers 202. The provider identification code can be the unique physician identification number (UPIN) or the national provider identifier (NPI), both assigned to providers 202 by the Department of Health and Human Services for its Medicare and Medicaid programs. The conversion tables stored in memory module 314 include a list of provider identification codes, each associated with their corresponding provider information. In other embodiments, the conversion between the provider identification code and the provider information can be completed by software, electronic inquiry, accessing of public or private databases, or some other method of converting between provider identification codes and provider information.

The reference database 316 stores, at least, background information of providers 202 and one or more tables for converting between a diagnosis or procedure and its corresponding code used on the claim forms 204. The reference database 316 can include background information of providers 202, such as their profiles (medical school, age, gender, etc.), demographics, practice group, and hospital affiliation. The reference database 316 can also store lookup tables containing coding systems, such as the ICD-9 and CPT codes. The system 300 uses these lookup tables when converting between a diagnosis or procedure and its corresponding code.

The computing platform 306 is also in communication with one or more processors 310. Users 312 interface with the system 300 through the processors 310. The user 312 can interface with the processor 310 in any suitable manner, for example, a series of one or more drop-down menus can be provided to allow the user 312 to enter a request. The users 312 can request information and reports from the system 300 through the processors 310. Each of the processors 310 includes a monitor and a keyboard where users 312 are able to enter requests for information and receive reports. The users 312 can be individuals or companies, such as a pharmaceutical company that wants to promote a new drug to a particular group of providers 202.

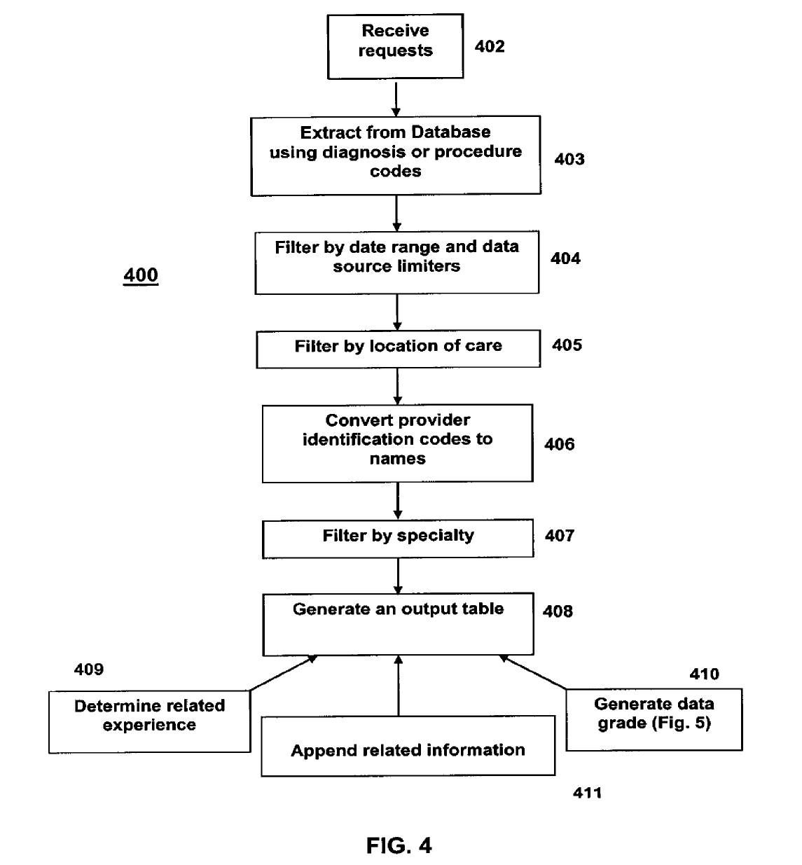

Referring to FIG. 4, a method 400 for providing reports and segmentation of physician activities is shown in a flow diagram. The system 300 can be adapted to carry out the method 400. Although FIG. 4 shows the steps being performed in a particular sequence, the steps can be performed in any order. For instance, the extracted datasets can be filtered based on location of care (step 405) before being filtered by date range (step 404). Furthermore, depending on the request of the user 312, some steps can be excluded.

The method 400 begins with step 402, where a request is received from the user 312. In the embodiment shown, the user 312 sends a request through the Internet 308 to the computing platform 306. The request can be for a list of providers 202 in a particular field of medicine and/or information relating to a segment of their activities. The request can be based on a name of a medical condition or a code. For example, the user 312 can enter “diabetes mellitus without complication” or ICD-9 code 250.0. If the user 312 provides only the name of the diagnosis and procedure, the computing platform 306 converts the name into the corresponding diagnosis or procedure code using a code lookup table stored in the reference database 316.

In step 403, after receiving the request from the user 312, medical claim datasets that contain the requested diagnosis or procedure code are extracted. In the system 300, the computing platform 306 searches the database 304 to extract medical claim datasets that contain the requested diagnosis or procedure code. The computing platform 306 uses a code representing the requested diagnosis or procedure to search the database 304 for all medical claim datasets that have that same diagnosis or procedure code. After the computing platform 306 has found datasets with a substantially matching diagnosis or procedure code, the computing platform 306 can extract all data fields of each matching dataset or a portion of the data fields of each matching dataset. The extracted datasets from the database 304 include provider identification codes. For example, if the user 312 requests information relating to a particular diagnosis, the computing platform 306 extracts datasets that contain a code corresponding to the requested diagnosis. Similarly, if the user 312 requests information relating to a procedure of a medical condition, the computing platform 306 extracts datasets that contain a code corresponding to the requested procedure. Alternatively, if the user 312 requests a list of providers 202 who diagnosed and then treated the same patient, i.e., the patient was diagnosed with a disease and then treated for that disease by the same provider 202, the computing platform 306 first uses a procedure code to extract datasets from the database 304, and then filters the extracted datasets using at least one diagnosis code. Thus, the above described “look-back” method can relate a procedure and a diagnosis of a particular medical claim form 204 to form a list of providers 202 who diagnosed and treated the same patient.

In step 404, the extracted datasets can be filtered for datasets within a particular period of time. In the system 300, the computing platform 306 determines if the request specifies a particular period of time, such as a particular date range. If so, it filters the datasets extracted in step 403 using the date of service entered on the medical claim forms 204 (Fields 17-20 in FIG. 1a). Filtering the extracted datasets using a date range provides the user 312 with a more relevant list of providers 202. For example, a user 312 may request a report of providers 202 who performed the highest number of diabetes diagnoses and treatments between January 1 and December 31 of the previous year because those providers 202 are more likely to diagnose and treat a high number of patients in the following year. The computing platform 306 uses the date range, if any, indicated in the user's request to select only those providers 202 who performed diabetes diagnoses and treatments within the date range specified in the request.

Even when the user 312 does not provide a date range, it may be useful for the computing platform 306 to filter the extracted datasets with a date range because datasets older than a certain number of years may no longer be relevant to the user 312. For example, a list of providers 202 who treated diabetes five years ago would likely not be relevant to the user 312. Therefore, in the embodiment shown, the computing platform 306 can be configured to filter for information that is not older than a particular age.

In addition to date range, in step 404, other parameters or limiters may be used to filter the extracted datasets, such as the data source. The user 312 may request dataset from a particular geographic area. The user 312 can enter geographic information (city, state, zip code, or other custom combination) of the providers 202 to filter the extracted datasets to a certain geographic location. Thus, a user 312, such as a pharmaceutical company, can redirect its marketing and sales teams to target new products and services to certain providers 202 in a certain geographic area.

In step 405, the computing platform 306 can filter the extracted information based on the location of care. Location of care is the location where the provider 202 performed the diagnosis or procedure. The location of care may be, for instance, a physician's office, inpatient hospital, outpatient hospital, emergency room, ambulatory surgery center, or some other location suitable for diagnosing or performing a procedure.

In the datasets extracted from the database 304, the names of the providers 202 are represented by provider identification codes. In step 406, the provider identification codes are converted into the names of the providers 202. In the system 300, the computing platform 306 converts the provider identification codes in the extracted datasets to their corresponding provider 202 names, and in the embodiment shown, the conversion is completed by use of conversion tables stored in the memory module 314 to match the provider identification codes with their corresponding names. Using the conversion tables in the memory module 314, the computing platform 306 can convert the provider identification codes in the extracted data into a list of names of providers 202. The computing platform 306 can also use the provider identification code to extract from the reference database 316 background information for each of the listed providers 202 and thereby forms a list of names and data associated, with those providers 202. Using that list of providers 202, the computing platform 306 can build an output table (step 408) according to the request of the user 312. The computing platform 306 can include only the names of the providers 202 or include the names and the background information of the providers 202 in the output table formed in step 408.

In step 407, the extracted data can be filtered by specialty of practice. In the system 300, the computing platform 306 can further narrow the list of the providers 202 based on their specialty of practice. For example, if a user 312 needs a list of providers 202 who specialize in coronary artery bypass surgery, the computing platform 306 finds the corresponding code in the reference database 316 and uses the corresponding code to narrow the list of providers 202 to those who specialize in coronary artery bypass surgeries. At this point, the computing platform 306 has a list of providers 202 whose medical claim datasets contain a particular code for a diagnosis or a procedure.

At step 408, an output table is formed from the extracted and filtered datasets. The datasets may have been filtered by a date range, location of care, provider specialties, combinations of the aforementioned, or some other data filter. In the system 300, the computing platform 306 uses the list of providers 202 to generate at least one output table that contains a segmentation of provider activities according to the request of the user 312. The computing platform 306 sorts the list of providers 202 according to the request of the user 312 in a descending or ascending order according to a particular data field specified by the user 312, such as the number of patient visits or the number of a particular diagnosis or a procedure performed by the providers 202. For example, the computing platform 306 can sort the list of selected providers 202 in a descending or ascending order according to the total number of patient visits for each provider 202, wherein a visit can include when a patient visits a provider 202 for diagnosis or treatment, and that provider 202 submits a medical claim form 204 to the clearinghouse 206. Each visit includes one or more diagnoses and procedures, and thus one or more corresponding diagnoses and procedure codes appear on the medical claim form 204. The medical claim form 204 provides data for a dataset in the database 304 with, at least, a provider identification code, a patient name or identification code, and a date of service. Also, the computing platform 306 can sort the list of providers 202 according to the request of the user 312 in a descending or ascending order according to, for example, the number of diagnoses or procedures performed by the providers 202. The computing platform 306 then selects the top number of providers 202 that satisfy the request of the user 312. For instance, when a user 312 requests the top 100 providers 202 who performed the highest number of diabetes diagnoses and treatments in the country last year, the computing platform 306 selects the top 100 providers 202 after it has sorted out the list of providers 202. Upon the completion of step 408, an output table is generated. The output table has one or more rows and columns that represent segmentations of the provider 202 activities. The columns can include one or more of the following: the names of the providers 202, the code representing the diagnosis or procedure requested by the user 312, the total number of visits for each provider 202, the total number of male or female patients for each provider 202, ranges of age for patients visiting a particular provider 202, or another data field in the dataset requested by the user 312. The computing platform 306 can format the output table in accordance with the request of the user 312. For example, the output table can be of a particular computer file format, accessible by a particular computer system or program, or have some other format requested by the user 312. The computing platform 306 can send the output table to the user 312, such as by making the list available on a website, displaying it on a processor 310, or sending it to the user's e-mail account.

In step 409, the method 400 can determine “related experience” and provide a column of “related experience” in the output table formed in step 408. Related experience, which may be valuable secondary information for the user 312, involves determining co-occurring experience that the providers 202 or patients may have. The related experience can be derived through additional filtering of the datasets to determine co-morbid conditions that may be of interest to the user 312 viewing primary information related to a particular data field. For example, the user 312 can request a list of providers 202 who performed open-heart surgery (primary information) but also have experience in angioplasty (secondary, related experience). Alternatively, the user 312 can request a list of providers 202 who performed heart surgery (primary information) where the patient has been previously diagnosed with diabetes mellitus, obesity, or high cholesterol (secondary information).

The computing platform 306 determines the related experience, step 409. To determine related experience, the user 312 provides a secondary code corresponding to a particular diagnosis or procedure, at step 409. Using the secondary code, the computing platform 306 extracts from the database 304 datasets that have the secondary code, step 409. The extracted datasets represent a secondary list of providers 202 whose datasets contain the secondary code. The computing platform 306 then compares the secondary list of providers 202 with the list of providers 202 in the output table from step 408. If the name or identification code of a provider 202 in the secondary list matches one in the output table, then the matching provider 202 in the output table has related experience. Accordingly, the computing platform 306 generates a “Y” or “Yes” in the related experience column in the output table for that provider 202. Otherwise, the computing platform 306 marks an “N” or “No.” In the embodiment shown, to expedite queries, if no related codes are requested by the user 312, the system 300 does not search the database 304 for datasets that have one or more related codes. In other embodiments, the system 300 can be adapted to search for related in the datasets of the database 304.

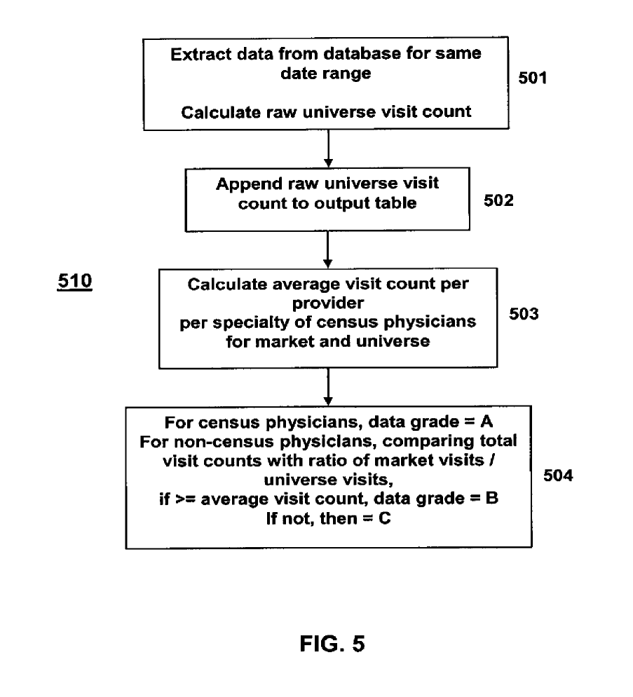

In step 410, the method 400 can generate a data grade representing how much data for a particular provider 202 has been obtained for that provider 202. The data grade can be based on the volume of data for a particular provider 202 and a comparison between the total number of visits that the provider 202 had with an average number of visits for other providers 202 in the same field and in the same time period. The output table of step 408 can then include a “Data Grade” column. The output table can include a column showing the total number of visits, i.e., diagnoses or procedures, for each of the providers 202. For some users 312, the total number of visits may be more meaningful when the output table shows the total number of visits in relation to the average number of visits for a provider 202 in the same field during the same period of time. The computing platform 306 provides the data grade by, for instance, first calculating an average visit count for all of the providers 202 in the database 304. The computing platform 306 then compares the average number of visits with the total number of visits for each provider 202 listed in the output table. Based on that comparison, the computing platform 306 indicates in the data grade column of the output table whether a particular provider 202 is above or below the average number of visits and by how many visits. The step 410 is shown in greater detail in FIG. 5.

In step 411, the output table from step 408 can include an appendix of information related to the providers 202, such as their profiles (medical school, age, gender, etc.), demographics, group practice, and hospital affiliation. In the system 300, the information of all providers 202 and their affiliations is stored in the reference database 316. After the background and profile information of the providers 202 is appended to the output table, the output table provides a substantially complete picture of the providers 202. The output table, therefore, is a generally comprehensive list of providers 202 and segmentation of their activities which can be used for in-depth targeting of new products or services offered by a user 312.

Referring to FIG. 5, a method 510 for providing a data grade to the total visit count of each provider 202 in the output table is shown in a flow diagram. The data grade is generated in step 410 of method 400, as shown in FIG. 4. The method 510 determines the ratio of market visits to universe visits. From the ratio, the method 510 generates a data grade.

At step 501, a raw universe visit count is determined. The raw universe visit count can be generated from summing all the visits of all the providers 202 for a selected procedure or diagnosis code and for a particular date range. The universe data is deemed raw data because it is data from the database 304. In the embodiment shown, to determine the raw universe count, the system 300 extracts datasets from the database 304 for a particular date range, and then generates the total number of visits for all of the providers 202. This can be done, for example, by adding the visit counts of all providers 202 from the output of step 404 of FIG. 4, or from the output table, step 408.

In step 502, the computing platform 306 can append the raw universe visit count to the output table. In step 503, an average visit count per provider 202 per specialty of census physicians for market and universe data is generated. The raw universe visit count can pull data of providers 202 who are submitting substantially 100% of their diagnosing activity to the clearinghouse 206 or the database 304. These providers 202 are termed “census physicians” because they supply substantially 100% of their activities or a census of their activities to the clearinghouse 206 or the database 304.

Market data includes information from the providers 202 that are based on the procedure or diagnosis code of interest plus one or more filtering criteria. In the system 300, the market data can include extracted datasets from the database 304 that have been filtered by, for example, a date range, data source limiters, location of care, specialty, combinations of the aforementioned, or some other filter. A market visit count includes a sum of all visits to providers 202 with the procedure or diagnosis code of interest plus one or more filtering criteria.

The universe data includes data from all providers 202 of interest. For example, in the system 300, the universe data can include all providers 202 who submitted medical claim forms within a predetermined date range. A universe visit count includes a sum of all visits to all the providers 202 of interest. The universe data can also include a universe visit count across all census physicians. The universe visit count may be a sum of all visits of all census physicians. The market visit count and the universe visit count can be used to generate a ratio of market visits to universe visits. The ratio of market visits to universe visits is then used to determine a data grade in step 504.

Additionally, the universe visit count is used to determine the gross number of visits that are ultimately applied to determine the providers 202 who are placed into a specific decile as reported by the system 300 or the method 400. For example, if the universe of market data shows providers 202 who have contributed 100,000 patient visits, the top decile of providers 202 includes the providers 202 having the highest number of visits (in descending order) that make up the top 10% (10,000) of the market data from the contributing providers 202. In the embodiment shown, the computing platform 306 calculates an average visit count per provider 202 per specialty of census physicians for market and universe data. The platform 306 then calculates a ratio of market visits and universe visits.

In step 504, a data grade is generated based on a comparison of total visit counts with a ratio of market visits to universe visits. In the embodiment shown, the computing platform 306 provides a data grade in the data grade column of the output table. For each “census physician,” the computing platform 306 provides a particular data grade, such as “A.” For each non-census physician, the computing platform 306 compares their total visit count with the ratio of market visits to universe visits. If the total visit count of a provider 202 listed in the output table is greater than or equal to the average visit count, the computing platform 306 assigns a data grade “B.” If the total visit count of a provider 202 listed in the output table is less than the average visit count, the computing platform 306 assigns a data grade “C.”

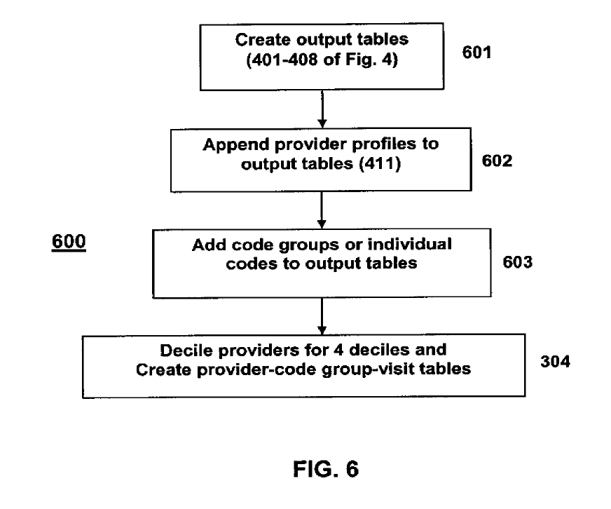

Referring to FIG. 6, another method 600 of providing reports of provider 202 activities is shown in a flow diagram. The method 600 is similar to that of method 400 in FIG. 4, except that the method 600 further provides the decile for the list of providers 202 in the output table. The list of data is first sorted in a descending or ascending order based on the total number of visits. Then the sorted list is divided into 10 groups having an approximately equal number of providers 202. Each group is a decile, representing an approximately 10 percent portion of the sorted list. The sorted list can also be quartiled into four groups having an approximately equal number of providers 202, so that each group is a quartile representing approximately 25 percent portion of the data. The method 600 can be performed by the computing platform 306 of FIG. 3.

At step 601, an output table is generated. The output table can be generated by steps 401 through 408 of FIG. 4. The output table generated by step 408 of FIG. 4 can also be called a physician-visit table where “Provider” refers to a column of the output table, i.e., list of providers 202 and “Visit” refers to a row of the output table, i.e., total number of visits for each provider 202.

In step 602, the computing platform 306 appends to the output table a summary of the provider profiles, as discussed above with respect to step 411 of FIG. 4. In step 603, upon request, the computing platform 306 can include a column of “code group” in the output table. A “code group” is a group of individual ICD-9 codes that may be tied together to expand more generally the definition of a condition in a clinically meaningful way. This is necessary to ensure that all aspects of the condition are contemplated when a group of providers 202 are pulled into the set of information to be studied. For example, a user interested in receiving information on provider activities related to diabetes would likely group not only the code 250.0 for diabetes mellitus without complication, but also the codes: 250.1 for diabetes with ketoacidosis; 250.2 for diabetes with hyperosmolar coma; 250.3 for diabetes with coma not elsewhere classified; 250.4 for diabetes with renal manifestations; 250.5 for diabetes with ophthalmic manifestations; 250.6 for diabetes with neurologic manifestations; 250.7 for diabetes with circulatory disorder; 250.8 for diabetes with manifestations not elsewhere classified; and 250.9 for diabetes with complications not otherwise classified.

Finally, in step 604, the computing platform 306 deciles the list of providers 202 in the output table by dividing the list of providers 202 into ten approximately equal parts. However, the list of providers 202 can also be apportioned in “deciles in total,” “deciles in groups,” or “decile individually.” For “decile in total,” all codes included in the list of providers 202 are grouped together and an output is created for the list as a whole. “Decile in groups” provides summary information for each of the deciles. For example, the output may show that those providers 202 classified in Decile 10 may see patients for a predetermined market code group at a rate of 100 visits per provider 202 while Decile 9 providers 202 may see patients at a rate of 75 visits per provider 202. For “decile individually,” a provider level output is created in the form of a table where each provider 202 is assigned a code in the database. Alternatively, the platform 306 may divide the list of providers 202 into four approximately equal quartiles, where each quartile is an approximately 25 percent portion of the list of providers 202. Quartiles can also be in total, in groups, or individually. The output table of FIG. 6 is a physician-code group-visit table in which providers 202 are ranked in deciles or quartiles. Four quartiles allow users 312 of the output table, such as a pharmaceutical company that produces a new drug, to promote their product to the providers 202 one quartile at a time.

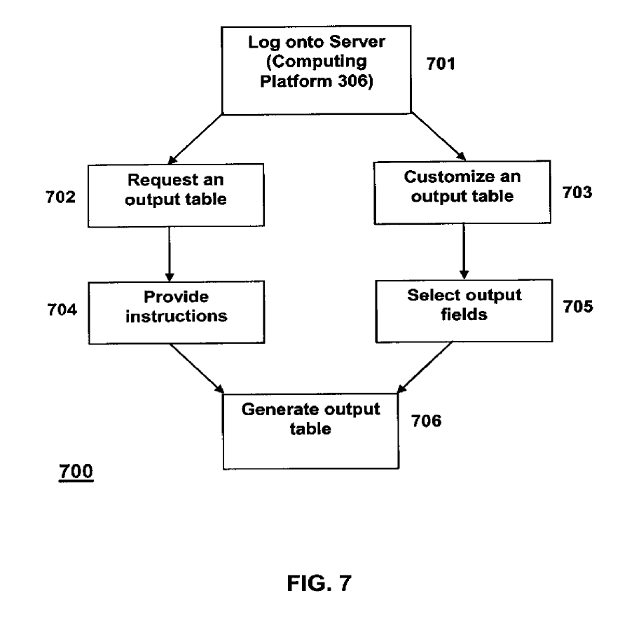

FIG. 7 illustrates a method for a user to order online a list of providers 202 and a segmentation of their activities. In step 701, the user 312 logs on with a unique identification and password to connect to the computing platform 306, as shown in FIG. 3, which can be a server. Once logged onto the computing platform 306, the user 312 can request an output table through one of two methods: (1) request that the entity (such as a clinic) that controls the computing platform 306 to provide an output table, at step 702; or (2) create a customized output table directly through the computing platform 306, at step 703.

If the user 312 requests that the entity controlling the computing platform 306 to generate an output table, step 702, the user is asked to provide specific instructions, step 704. Specific instructions include the type or code of diagnosis and procedure that the user 312 is interested in obtaining information about. Then the entity generates the output table, step 706, and provides the output table to the user 312.

If the user 312 chooses to create a customized output table, step 703, the user 312 provides a diagnosis or procedure code of interest. In one embodiment, the user 312 uses an interface that includes a link for “Reference—DOI Builder.” The user 312 can click on the “Reference—DOI Builder” link, in which DOI stands for “diagnosis of interest.” The “DOI Builder” is an internal procedure of the computing platform 302 with a front end tool that permits the user 312 to specify the ICD-9, CPT or HCPCS codes of interest for the output table. With the DOI Builder, the user 312 can view the lists of ICD-9, CPT and HCPCS codes and the descriptions of the codes. The user 312 can then select a diagnosis or procedure code. If the user 312 has questions about how to use the DOI Builder, the user 312 can click on “Help—DOI Builder User Guide” (not shown).

At step 705, after entering the diagnosis or procedure code, the user 312 provides additional instructions regarding the output table. In one embodiment, the system 300 provides the user 312 with an interface where the user 312 can fill in instructions. A plurality of information fields for customizing the output, as shown in Table 1 below, is then displayed for the user 312, and the user 312 selects one or more of the information fields. In Table 1, “Information Field” is the list of columns that the user 312 can select for the output table. The “Output Option” describes the output option to which the information field belongs. Thus, for example, if the user 312 selects the “Physician Demographics” output option, the output table can include the first name, the last name, city, state, zip code, address, and specialty group of each provider 202 listed in the output table. Thus, the user 312 can customize the columns of information in the output table. The output table can include all or some of the information fields or columns listed below. At step 706, the computing platform 306 builds an output table according to the column names or output fields that the user 312 selected from Table 1, step 705, or the instructions from the user 312 in step 704. The computing platform 306 then sends the output table report to the user 312 via e-mail. The computing platform 306 utilizes the output fields selected by the user 312 to control the layout of the output table and determine which metrics to use.

TABLE 1
Output Data Fields

| Output Option | Information Field |
|---|---|
| Standard | Physician ID |
| Standard | NPI (National Provider Identifier) |
| Standard | AMA (American Medical |
| | Association) |
| Standard | DEA (Drug Enforcement |
| | Administration) |
| Standard | UPIN (Unique Physician |
| | Identification Number) |
| Standard | State License |
| Standard | Tax ID |
| Physician Demographics | First Name |
| Physician Demographics | Last Name |
| Physician Demographics | City |
| Physician Demographics | State |
| Physician Demographics | Zip code |
| Physician Demographics | Address |
| Physician Demographics | Specialty Group |
| Data Grade | Data Grade |
| Related Experience | Related Experience |
| Total/Group/Individual Code | Code Group |
| Market Volume | Market Volume |
| Standard | Market Decile % of Visits |
| Standard | Market Decile % of Providers |
| Decile Within Specialty | Market Decile Within Specialty % |
| | of Visits |
| Decile Within Specialty | Market Decile Within Specialty % |
| | of Providers |
| Market Patient Profile | Male Patients % Visits |
| Market Patient Profile | Female Patients % Visits |
| Market Patient Profile | Patients Age 0-19 % Visits |
| Market Patient Profile | Patients Age 20-34 % Visits |
| Market Patient Profile | Patients Age 35-49 % Visits |
| Market Patient Profile | Patients Age 50-64 % Visits |
| Market Patient Profile | Patients Age 65+ % Visits |
| Market Payer Profile | Medicare % Visits |
| Market Payer Profile | Medicaid % Visits |
| Market Payer Profile | Other % Visits |
| Market Payer Profile | Commercial % Visits |
| Market Payer Profile | Payer #1 Name |
| Market Payer Profile | Payer #1 % Visits |
| Market Payer Profile | Payer #2 Name |
| Market Payer Profile | Payer #2 % Visits |
| Market Payer Profile | Payer #3 Name |
| Market Payer Profile | Payer #3 % Visits |
| Market Payer Profile | Payer #4 Name |
| Market Payer Profile | Payer #4 % Visits |
| Market Payer Profile | Payer #5 Name |
| Market Payer Profile | Payer'#S % Visits |
| Market Location of Care Profile | Office % Visits |
| Market Location of Care Profile | Inpatient Hospital % Visits |
| v1arket Location of Care Profile | Outpatient Hospital % Visits |
| Market Location of Care Profile | Emergency Room % Visits |
| Market Location of Care Profile | Ambulatory Surgery Center % Visits |
| Market Location of Care Profile | Other % Visits |
| Universe Decile | Universe Decile % Visits |
| Universe Decile | Universe Decile % Physicians |
| Universe Decile Within Specialty | Universe Decile Within Specialty % |
| | Visits |
| Universe Decile Within Specialty | Universe Decile Within Specialty % |
| | Visits |
| Universe Patient Profile | Male Patients % Visits |
| Universe Patient Profile | Female Patients % Visits |
| Universe Patient Profile | Patients Age 0-19 % Visits |
| Universe Patient Profile | Patients Age 20-34 % Visits |
| Universe Patient Profile | Patients Age 35-49 % Visits |
| Universe Patient Profile | Patients Age 50-64 % Visits |
| Universe Patient Profile | Patients Age 65+ % Visits |
| Universe Payer Profile | Medic; are % Visits |
| Universe Payer Profile | Medicaid % Visits |
| Universe Payer Profile | Other % Visits |
| Universe Payer Profile | Commercial % Visits |
| Universe Payer Profile | Payer #1 Name |
| Universe Payer Profile | Payer #1 % Visits |
| Universe Payer Profile | Payer #2 Name |
| Universe Payer Profile | Payer #2 % Visits |
| Universe Payer Profile | Payer #3 Name |
| Universe Payer Profile | Payer #3 % Visits |
| Universe Payer Profile | Payer #4 Name |
| Universe Payer Profile | Payer #4 % Visits |
| Universe Payer Profile | Payer #5 Name |
| Universe Payer Profile | Payer #5 % Visits |
| Universe Location of Care Profile | Office % Visits |
| Universe Location of Care Profile | Inpatient Hospital % Visits |
| Universe Location of Care Profile | Outpatient Hospital % Visits |
| Universe Location of Care Profile | Emergency Room % Visits |
| Universe Location of Care Profile | Ambulatory Surgery Center % Visits |
| Universe Location of Care Profile | Other % Visits |

As shown in Table 1, the types of output options for an output table can include “Market Patient Profile,” “Universe Patient Profile,” “Market Payer Profile,” “Universe Payer Profile,” and others. The aforementioned profiles can be determined on a market basis and a universe basis for each provider 202 in the output. Market metrics are based on the diagnosis or procedure database in the system 300. Universe metrics assess all diagnosis claims (“Dx”) for the providers 202 associated with the diagnoses and procedures from the database. Dx data allows for a text string containing more than one diagnosis code per procedure. The market and universe patient profiles mentioned in Table 1 provides percentage of visits segmented by patient age and age groups. The market and universe payer profiles provide information of percentage of visits segmented by pay type and top commercial payers. Location of Care Profile provides information about percentage of visits segmented by location of care, including office, inpatient hospital, outpatient hospital, emergency room, ambulatory surgery center, and others.

Exemplary output tables 800-1100 are shown in FIGS. 8-11, respectively. The exemplary output tables 800-1100 of FIGS. 8-11 are for illustrative purposes only, and other output tables, having different formats or content, can be generated. For instance, the user 312 can select how many providers 202 to have in the “Physician” column and which columns of information are to be included in the output tables. In addition, the diagnosis or procedure code can be put in the table header and the “Code Group” column can be eliminated.

Referring to FIG. 8, an output table 800 is shown according to an exemplary embodiment of the present invention. The output table 800 represents a report and a segmentation of activities of the top five providers 202, Physicians A through E, who have the highest number of visits in a predetermined field of interest. This report would be generated if a user 312 requests a list of the top five providers 202 who performed the highest number of diabetic diagnosis in a predetermined year in a predetermined location, such as the year 2008 in the United States. The code for diabetic diagnosis, for example, is given as 11111. The user 312 logs on to the server or computing platform 306 of FIG. 3 to enter the request. After receiving the code 11111, the computing platform 306 searches the database 304 and extracts from the database 304 substantially all datasets that have the diagnosis code 11111. The computing platform 306 then filters the extracted datasets by date range, for example, filtering datasets that have a service date of between, for example, Jan. 1, 2008 through Dec. 31, 2008. The result is a raw universe data with medical claim datasets of providers 202 who performed diabetic diagnosis (code 11111) during 2008 in the United States.

The computing platform 306 then filters the extracted datasets by location of care. In this example, the user 302 did not specify a preferred location of care, so the computing platform 306 does not perform that step. If, however, the user 312 wishes a list of providers 202 who performed diabetic diagnoses in outpatient hospitals, the computing platform 306 would further filter the extracted datasets by outpatient hospitals.

At this point, the extracted and filtered datasets contain provider identification codes, but not the names of the provider 202. Next, the computing platform 306 uses the conversion table in memory 314 to convert provider identification codes in the extracted datasets into provider names.

From this raw universe data, the computing platform 306 sorts the datasets based on the total number of visits for each provider 202. Because each dataset is from one medical claim form 204, filled out by one provider 202, each dataset has one provider identification code. If, for example, Physician A diagnosed 126 patients for diabetes in 2008, he would have submitted 126 separate medical claim forms 204 to the clearinghouse 206 for payment or reimbursement. Each form is filled with Physician A's provider identification code. From the raw universe data, the computing platform 306 adds the number of datasets that have the same physician identification code for Physician A. Because Physician A submitted 126 medical claim forms, the computing platform 306 finds 126 datasets with Physician A's identification code. When the computing platform 306 counts those datasets, it generates a “126” representing the total number of visits with a diabetes diagnosis for Physician A.

After calculating the total number of visits for each provider 202, the computing platform 306 sorts the list in a descending order according to the total number of visits. If, for instance, Physician A performed the highest number of diabetes diagnoses in the country in 2008, his name would be on the top of the list. Because the user 312 requested the top five providers 202 in the country, the computing platform 306 selects the top five providers 202 to show in the output table 800.

As shown in output table 800, the top five providers 202, Physicians A through E, are shown in the first column, the “Provider” column. Here, “Physician A” represents an actual name of a first physician, “Physician B” represents the actual name of a second physician, “Physician C” represents the actual name of a third physician, “Physician D” represents the actual name of a fourth physician, and “Physician E” represents the actual name of a fifth physician. The second column is for the “Code Group,” in this case code 11111 for diagnosis of diabetes. The third column is for “Market Volume.” The “Market Volume” column provides the user 312 with the total number of diagnoses for the top five providers 202. In output table 800, the “Market Volume” column shows the total number of visits that each provider 202 had in the year 2008. The numbers in the “Market Volume” column are sorted in descending order from the provider 202 with the most visits to the provider 202 with the least visits. In the output table 800 shown, Physician A had 126 visits, Physician B had 95 visits, Physician C had 78 visits, Physician D had 65 visits, and Physician E had 62 visits. Thus, Physician A who had the most visits amongst Physicians A through E (126 visits) is listed at the top of the output table 800, and Physician E who had the least visits amongst the same group of providers 202 (62 visits) is listed at the bottom of the table.

The other columns in the output table 800 are “Market Decile % of Visits,” “Market Decile % of Providers,” “Market Decile Within Specialty % of Visits,” and “Market Decile Within Specialty % of Providers” The “Market Decile % of Visits” is based on the total number of visits for the overall decile group, divided by the total number of visits for the code across all decile groups. This figure is close to 10% for a deciled report. It may not be exactly equal to 10%, as the deciling procedure may attribute an unequal number of visits to each decile group because at least two of the listed providers 202 may have had the same number of visits. The sum total of this variable across the decile groups will equal 100%. The “Market Decile % of Providers” for each decile group performs a similar calculation except that the calculation equals % of providers 202 for each decile group divided by the gross total of providers 202 profiled across all deciles. The sum of these percentages across all deciles will equal 100%. The “Market Decile Within Specialty % of Visits” performs the same calculation as the “% of Visits” calculation except it filters out all specialty visit information that may not be of interest to the user 312 (for example, for diabetes, a user may want to simply view the contribution of endocrinologists vs. primary care physicians for the visits).

The sum of these percentages across all deciles equals 100%. Similarly, the “Market Decile Within Specialty % of Providers” performs the same calculation as the “Market Decile % of Providers” calculation except it filters out all providers 202 whose specialty may not be of interest to the user 312 (for example, for diabetes, a user 312 may want to simply view the contribution of endocrinologists vs. primary care physicians for the visits). The sum of these percentages across all deciles equals 100%. A user 312, such as a company, can use the information in the output table 800 to size the opportunity for groups of providers 202 that may be of interest. For example, a company with limited resources may decide to target those providers 202 who see at least 75 patients for a given condition or alternatively target only 1,000 providers 202 of interest. The statistics may also help a user 312 determine how deep within the prescriber base the targeting opportunity exists.

Referring to FIG. 9, an output table 900 is shown with columns for location of care. The output table 900 includes the same top five providers 202 of FIG. 8 who performed the highest number of diabetic diagnosis in 2008, but the output table 900 includes a column indicating locations of care. Thus, the output table 900 indicates where the providers 202 performed the diagnoses or procedures. The output table 900 provides a percentage indicating the location of care where the top five providers 202 performed their diabetes diagnoses. The first column in the output table 900 is the names of the providers 202, Physicians A through E. In output table 900, the locations of care are divided into five categories: office, inpatient hospital, outpatient hospital, emergency room, and ambulatory surgery center. The information regarding the location of care is entered in the medical claim forms and thus included in the datasets of database 304. For Physician A, out of the 126 diabetic diagnoses that he performed in 2008, 90% were in a private office and 10% in outpatient hospitals. For Physician B, out of 95 diabetic diagnoses performed in 2008, 20% were in a private office and 80% in an outpatient hospital. For Physician C, 100% of his 78 diagnoses were performed in an emergency room. For Physician D, 50% of 65 diagnoses were performed in a private office and 50% in an outpatient hospital. For Physician E, 40% of 62 diagnoses were performed in a private office and 60% in an ambulatory surgery center. As shown in FIG. 9, the sum of the percentages of locations of care for each physician is 100%.

Referring to FIG. 10, an output table 1000 is shown with the age ranges of the patients. Although not shown, the output table 1100 can also include a percentage breakdown of demographic information, such as patient gender. The first column in the output table 1000 has the same top five providers 202, Physicians A through E, of FIG. 8. The output table 1100 further includes columns with the percentage of visits of patients in age ranges 0 to 19, 20 to 34, 35 to 49, 50 to 64, and above 65. As shown in the output table 1000, 100% of the patients that Physician A diagnosed with diabetes in 2008 were above 65 years old. For Physician B, 50% were between 0 and 19 years old, and 50% were above 65 years old. For Physician C, 17% were between 0 and 19; 17% were between 20 and 34; 50% were between 35 and 49; and 16% were between 50 and 64. For Physician D, 4% of the patients were between 20 and 34; 4% were between 35 and 49; 22% were between 50 and 64; and 70% were above 65. Output table 1000 shows that Physicians A, B, and D diagnosed a high number of senior citizens in 2008, i.e., patients over 65 years of age. Thus, if a user 312, such as a pharmaceutical company, wishes to promote their diabetes-related products for senior citizens, the user 312 may want to promote their products to Physicians A, B, and D.

Referring to FIG. 11, an output table 1100 is shown with payer types. In the output table 1100, the first column is the list of the top five providers 202, Physicians A through E of FIG. 8. The second column of output table 1100, “Commercial % Visits,” classifies those visits in which the patient paid the provider 202 for services the provider 202 rendered using private, non-government affiliated insurance programs (e.g. non-Medicaid or non-Medicare payments). For example, 100% of the visits that Physician A had in 2008 were commercial, while Physician B had 15%, Physician C had 98%, Physician D had 13%, and Physician E had 32%. Other columns in output table 1100 include payer names and percentage of payments. For example, Physician A received 100% of payment from one commercial insurance company, Humana Health Plan, while Physician B received only 15% of payment from commercial insurance companies, 50% of which was from Medicare Part B California, and 50% from Secure Horizons insurance company. For Physician C, 75% was from Blue Cross of California and 13% from California Farm Life Insurance Company. For Physician D, 92% of payment was from Medicare and 4% from Blue Shield California. For Physician E, 100% of payment was from Medicare. In addition, the total percentage of payment for some providers 202, such as Physician C and D, is not 100%. For example, the output table 1100 shows that Physician C receives only 75% from Blue Cross and 13% from California Farm Life Insurance, which is a total of 88%. The other 12% of payment can be from other payers not shown in the output table 1100 or by cash payments from the patients. The breakdown of the payer types as shown in the output table 1100 allows a user 312 to determine, for instance, the income status of the patients.

As shown in the exemplary output tables of FIGS. 8-11, providers 202 can be deciled based on the frequency of diagnoses and volume of procedures within specialty groups. The volume of a selected procedure or diagnosis can also be compared to the total universe of procedures and diagnoses for each provider 202. Moreover, the output tables 800-1100 include a wide variety of data for the user 312, including total number of patients seen by each provider 202, percent of visits by patient age, percent of visits by patient gender, percent of visits by payer, or percent of visits at a particular location such as an office, an ambulatory surgery center, an inpatient hospital, an outpatient hospital, or an ER.

As a result of the flexibility and wide range of data, users 312 can utilize the system 300 to pinpoint the exact market the user 312 should try to reach. Thus, for example, the user 312 can deploy its sales force quickly and efficiently to high value providers 202. Also, market segmentation profiles can be created to refine business planning, territory sizing, and resource allocation. Return on non-personal promotions can be maximized, by ensuring that key providers 202 receive timely, relevant product information.

While preferred embodiments of the invention have been set forth above, those skilled in the art will readily appreciate that other embodiments can be realized within the scope of the invention. For instance, although the present invention describes an exemplary embodiment for segmenting the activities of providers 202, such as physicians, the present invention can be used for other providers 202, such as dentists. The present invention, therefore, should be construed as limited only by the appended claims.

1-19. (canceled)

20. A method of identifying records in a stream of encrypted data, the method comprising:
receiving, by a server system, a first stream of encrypted transaction data from a first stream source, the encrypted transaction data identifying (i) a transaction associated with an electronic medical claim form, and (ii) a first set of encrypted data fields corresponding to the transaction, the first set of encrypted data fields reflecting one or more results from at least one unencrypted parameter that has been encrypted;
receiving, by the server system, a second stream of encrypted transaction data from a second stream source, the encrypted transaction data identifying a second set of encrypted data fields determined to be associated with the transaction, the second set of encrypted data fields reflecting one or more results from at least one unencrypted parameter that has been encrypted;
generating, by the server system, based on the first set of encrypted data fields and within a longitudinal database associated with the computer system, a first longitudinal mapping for the transaction;
generating, by the server system, based on the second set of encrypted data fields and within the longitudinal database, a second longitudinal mapping for the transaction;
generating, by the server system, a linked record for the transaction within the longitudinal database based on associating the first longitudinal mapping and the second longitudinal mapping;
receiving, by the server system from a client device over a network, data indicating a request for provider information associated with the medical form;
in response to receiving the data indicating the request for provider information associated with the transaction, accessing, by the server system and from the longitudinal database, the linked record to (i) identify one or more providers indicated within the linked record, and (ii) select a particular set of encrypted data fields corresponding to the requested provider information;
determining, by the server system and for each of the one or more identified providers indicated within the linked record, a number of data fields from among the particular set of encrypted data fields that are associated with a particular provider; and
providing, by the server system and for output to the client device over the network, data indicating (i) the one or more identified providers, and (ii) for each of the one or more identified providers, corresponding data fields from among the particular set of encrypted data fields.

21. The method of claim 20, wherein at least one of the first set of encrypted data fields comprises a diagnosis code for a particular diagnosed medical condition or a performed medical procedure.

22. The method of claim 20, wherein at least one of the first second of encrypted data fields comprises a provider identifier for a particular provider.

23. The method of claim 20, wherein the data that is provided for output to the client device comprises an output table with at least one of a diagnosis code, a procedure code, a location of care, patients by age, or payer information.

24. The method of claim 20, wherein accessing the linked record comprises filtering the particular set of encrypted data fields according to at least one of a period of time, a geographic location, a location of care, or a specialty of medicine.

25. A system comprising:
one or more computers; and
one or more computer-readable media including instructions that, when executed by the one or more computers, cause performance of operations comprising:
receiving, by a server system, a first stream of encrypted transaction data from a first stream source, the encrypted transaction data identifying (i) a transaction associated with an electronic medical claim form, and (ii) a first set of encrypted data fields corresponding to the transaction, the first set of encrypted data fields reflecting one or more results from at least one unencrypted parameter that has been encrypted;
receiving, by the server system, a second stream of encrypted transaction data from a second stream source, the encrypted transaction data identifying a second set of encrypted data fields determined to be associated with the transaction, the second set of encrypted data fields reflecting one or more results from at least one unencrypted parameter that has been encrypted;
generating, by the server system, based on the first set of encrypted data fields and within a longitudinal database associated with the computer system, a first longitudinal mapping for the transaction;
generating, by the server system, based on the second set of encrypted data fields and within the longitudinal database, a second longitudinal mapping for the transaction;
generating, by the server system, a linked record for the transaction within the longitudinal database based on associating the first longitudinal mapping and the second longitudinal mapping;
receiving, by the server system from a client device over a network, data indicating a request for provider information associated with the medical form;
in response to receiving the data indicating the request for provider information associated with the transaction, accessing, by the server system and from the longitudinal database, the linked record to (i) identify one or more providers indicated within the linked record, and (ii) select a particular set of encrypted data fields corresponding to the requested provider information;
determining, by the server system and for each of the one or more identified providers indicated within the linked record, a number of data fields from among the particular set of encrypted data fields that are associated with a particular provider; and
providing, by the server system and for output to the client device over the network, data indicating (i) the one or more identified providers, and (ii) for each of the one or more identified providers, corresponding data fields from among the particular set of encrypted data fields.

26. The system of claim 25, wherein at least one of the first set of encrypted data fields comprises a diagnosis code for a particular diagnosed medical condition or a performed medical procedure.

27. The system of claim 25, wherein at least one of the first second of encrypted data fields comprises a provider identifier for a particular provider.

28. The system of claim 25, wherein the data that is provided for output to the client device comprises an output table with at least one of a diagnosis code, a procedure code, a location of care, patients by age, or payer information.

29. The system of claim 25, wherein accessing the linked record comprises filtering the particular set of encrypted data fields according to at least one of a period of time, a geographic location, a location of care, or a specialty of medicine.

30. A non-transitory computer storage device encoded with a computer program, the program comprising instructions that when executed by one or more computers cause the one or more computers to perform operations comprising:
receiving, by a server system, a first stream of encrypted transaction data from a first stream source, the encrypted transaction data identifying (i) a transaction associated with an electronic medical claim form, and (ii) a first set of encrypted data fields corresponding to the transaction, the first set of encrypted data fields reflecting one or more results from at least one unencrypted parameter that has been encrypted;
receiving, by the server system, a second stream of encrypted transaction data from a second stream source, the encrypted transaction data identifying a second set of encrypted data fields determined to be associated with the transaction, the second set of encrypted data fields reflecting one or more results from at least one unencrypted parameter that has been encrypted;
generating, by the server system, based on the first set of encrypted data fields and within a longitudinal database associated with the computer system, a first longitudinal mapping for the transaction;
generating, by the server system, based on the second set of encrypted data fields and within the longitudinal database, a second longitudinal mapping for the transaction;
generating, by the server system, a linked record for the transaction within the longitudinal database based on associating the first longitudinal mapping and the second longitudinal mapping;
receiving, by the server system from a client device over a network, data indicating a request for provider information associated with the medical form;
in response to receiving the data indicating the request for provider information associated with the transaction, accessing, by the server system and from the longitudinal database, the linked record to (i) identify one or more providers indicated within the linked record, and (ii) select a particular set of encrypted data fields corresponding to the requested provider information;
determining, by the server system and for each of the one or more identified providers indicated within the linked record, a number of data fields from among the particular set of encrypted data fields that are associated with a particular provider; and
providing, by the server system and for output to the client device over the network, data indicating (i) the one or more identified providers, and (ii) for each of the one or more identified providers, corresponding data fields from among the particular set of encrypted data fields.

31. The non-transitory computer storage device of claim 30, wherein at least one of the first set of encrypted data fields comprises a diagnosis code for a particular diagnosed medical condition or a performed medical procedure.

32. The non-transitory computer storage device of claim 30, wherein at least one of the first second of encrypted data fields comprises a provider identifier for a particular provider.

33. The non-transitory computer storage device of claim 30, wherein the data that is provided for output to the client device comprises an output table with at least one of a diagnosis code, a procedure code, a location of care, patients by age, or payer information.

34. The non-transitory computer storage device of claim 30, wherein accessing the linked record comprises filtering the particular set of encrypted data fields according to at least one of a period of time, a geographic location, a location of care, or a specialty of medicine.
